(19) United States
(12) Patent Application Publication
(10) Pub. No.: US 2025/0241275 A1
(43) Pub. Date: Jul. 31, 2025

(54) INTELLIGENT PET ORAL CLEANING WATER DISPENSER

(71) Applicant: TailnTail Corp., Markham (CA)

(72) Inventors: Qiang Dai, Haikou (CN); Sheng Feng, Haikou (CN); Kai Wei, Haikou (CN)

(21) Appl. No.: 18/613,716

(22) Filed: Mar. 22, 2024

(30) Foreign Application Priority Data
Jan. 30, 2024 (CN) 2024101236405

(51) Int. Cl. A01K 7/02

(52) U.S. Cl. CPC A01K 7/02

(57) ABSTRACT

An intelligent pet oral cleaning water dispenser comprises a water tank; a detachable water storage area and a host machine are arranged on the water tank; a water leakage port is arranged on the detachable water storage area; a filter screen is arranged below the water leakage port; a diverted and distributed water pipe is arranged on the uppermost part of the host machine; the bottom of the diverted and distributed water pipe is connected to a water outlet; a water inlet is arranged next to the water outlet; a reaction tank is arranged below the water inlet and the water outlet; a micropump is arranged below the reaction tank; a circuit board is arranged next to the micropump; a switch and a charging port are arranged on the circuit board; a battery is arranged below the micropump.

### 1. TECHNICAL FIELD

The invention relates to the technical field of pet water dispensers, in particular to an intelligent pet oral cleaning water dispenser.

### 2. BACKGROUND ART

The “China' s Pet Industry White Paper (Consumer Report) 2023-2024” shows that in 2023, the size of the consumption market for urban pets (dogs and cats) reached 279. 3 billion yuan. The aging population and the increasing number of people living alone are driving the continuous prosperity of the pet market. At present, China has become the world' s second-largest pet market. Along with the prosperity of the pet market, health issues concerning pets have attracted increasing attention.

Pets (such as cats and dogs) have a tooth structure very similar to that of humans. Their unique dietary habits and living habits make it difficult for them to engage in oral care as frequently as humans do. Prolonged bacterial growth and food residue accumulation make pets highly susceptible to oral health issues. According to surveys, over 80% of pets (aged three and above) suffer from oral diseases, including periodontal disease, gingivitis, and oral tumors. Oral diseases in pets typically originate from bacterial growth in the gingival sulcus, gradually forming dental plaque, leading to periodontal disease accompanied by symptoms such as bad breath and drooling. Oral diseases can affect the chewing ability of pets, causing a decrease in their food intake, and even refusal to eat, seriously impacting the gastrointestinal function and life safety of pets.

To address the oral diseases of pets, various products such as pet toothpaste, toothbrushes, and dental chew sticks have been developed in the market. However, due to the habits of pets, it is often challenging to clean their teeth regularly like humans do. Additionally, these products are typically expensive. At present, there are also several types of pet tooth cleaning water available in the market, which use certain chemical components to provide oral disinfection. Different from the mouthwash for humans, pet mouthwash needs to enter the pet's body, so its ingredients must be clean, hygienic, and harmless to animals. However, the added chemical components may pose a certain threat to pet health after entering their bodies. Moreover, existing tooth cleaning water in the market is expensive, and the effective lifespan of its active components and active flora faces the risk of becoming inactivated over time, making it difficult to achieve intelligent on-demand production.

### 3. SUMMARY OF THE INVENTION

The object of the invention is to solve the problems raised in the above background art, and provide an intelligent pet oral cleaning water dispenser.

In order to solve the above technical problems, the invention provides the following technical scheme: an intelligent pet oral cleaning water dispenser comprises a water tank; a detachable water storage area and a host machine are arranged on the water tank; a water leakage port is arranged on the detachable water storage area; a filter screen is arranged below the water leakage port; a diverted and distributed water pipe is arranged on the uppermost part of the host machine; the bottom of the diverted and distributed water pipe is connected to a water outlet; a water inlet is arranged next to the water outlet; a reaction tank is arranged below the water inlet and the water outlet; a micropump is arranged below the reaction tank; a circuit board is arranged next to the micropump; a switch and a charging port are arranged on the circuit board; a battery is arranged below the micropump.

Preferably, the water inlet is connected to the water body of the water tank through a latex hose; one end of the latex hose immersed in the water tank is connected to the filter head.

Preferably, an anode plate and a cathode plate are arranged in the reaction tank.

Preferably, a hook is arranged on the host machine for easy fixation on the tank.

Preferably, both the water tank and the reaction tank are made of polypropylene or acrylonitrile-butadiene-styrene copolymer.

Preferably, the electrode sheet is a porous electrode sheet.

The advantages of the invention are as follows: the intelligent pet oral cleaning water dispenser is intelligent and portable. With just one press of a button, it generates oxygen and hydrogen micro-nano bubbles with sterilizing properties through the built-in electrode sheets. By utilizing the bactericidal effect of micro-nano bubbles, it inhibits the proliferation of oral bacteria in pets, achieving pet oral cleanliness. It can be produced on-demand, ensuring stable activity. It enables one-touch on-demand production of pet oral cleaning water, ensuring the activity of active ingredients. The active ingredients are hydrogen and oxygen micro-nano bubbles, derived from water without the addition of extra chemical agents, making it clean and pollution-free. Therefore, it is an ideal pet oral water dispenser.

### 4. BRIEF DESCRIPTION OF ACCOMPANY DRAWINGS

FIG. 1 is a front view of the structure of the invention.

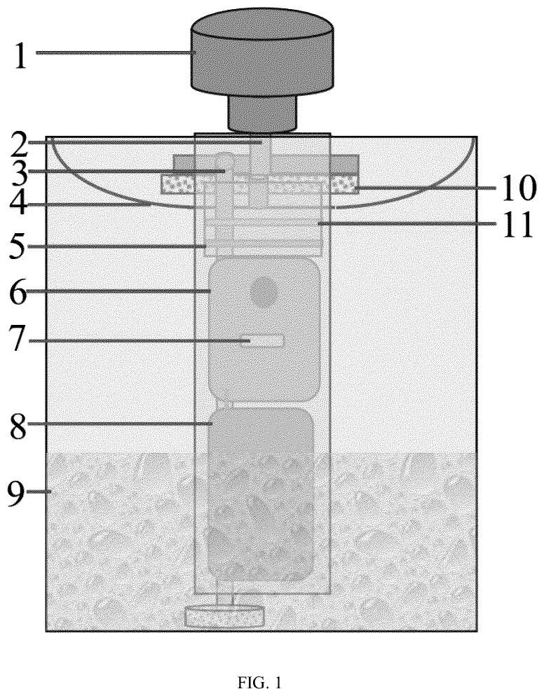

FIG. 2 is a rear view of the structure of the invention.

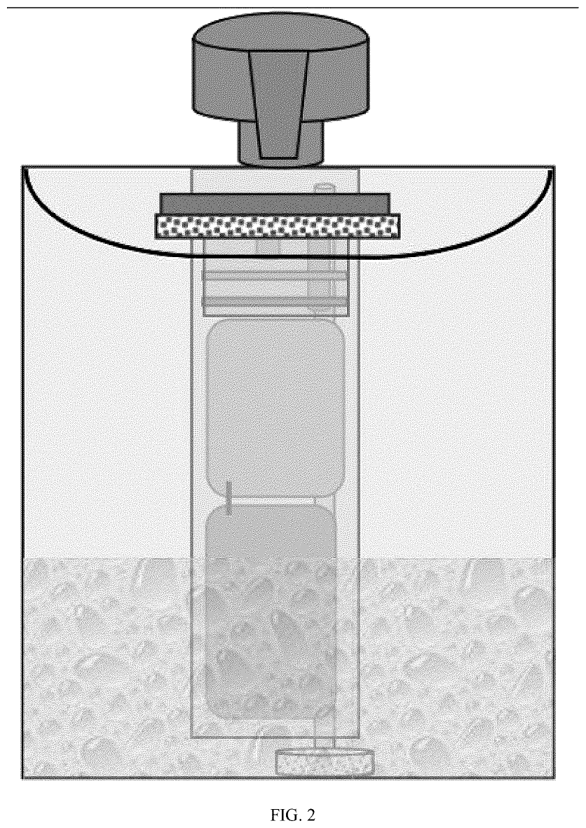

FIG. 3 is a left view of the structure of the invention.

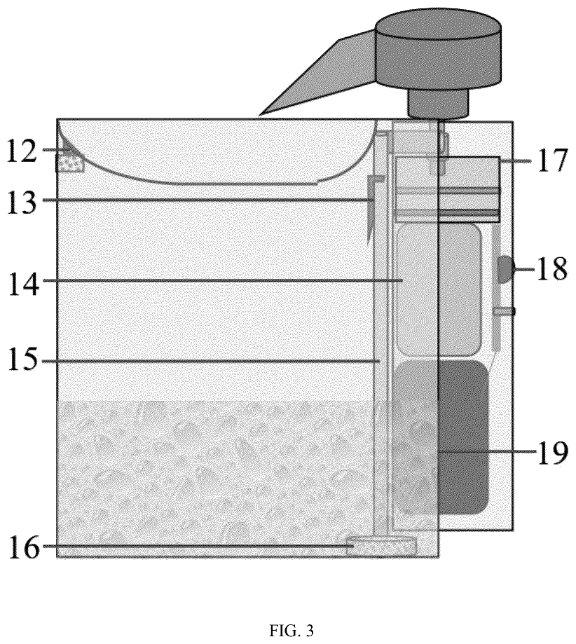

FIG. 4 is a right view of the structure of the invention.

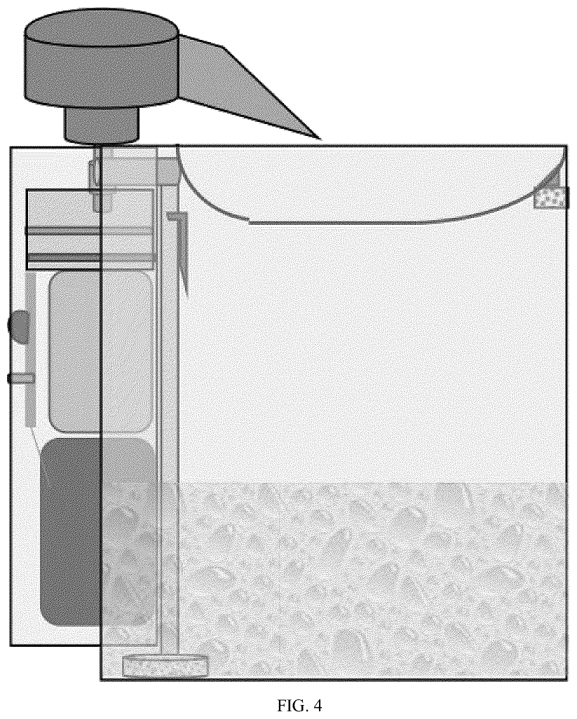

FIG. 5 is a top view of the structure of the invention.

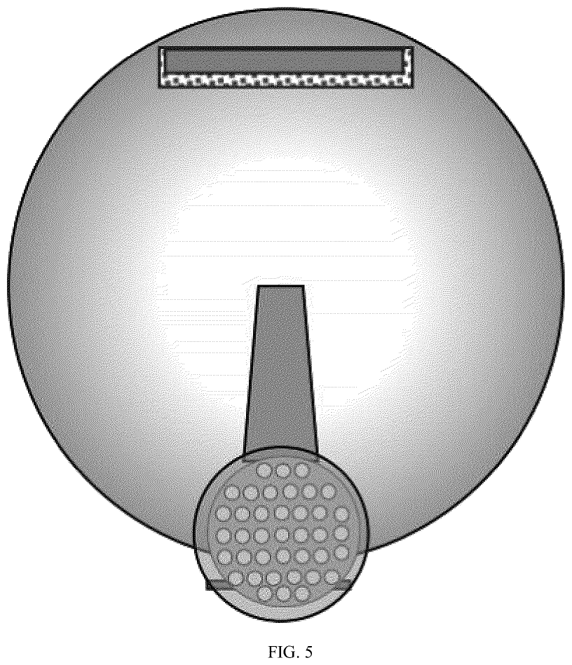

FIG. 6 is a a bottom view of the structure of the invention.

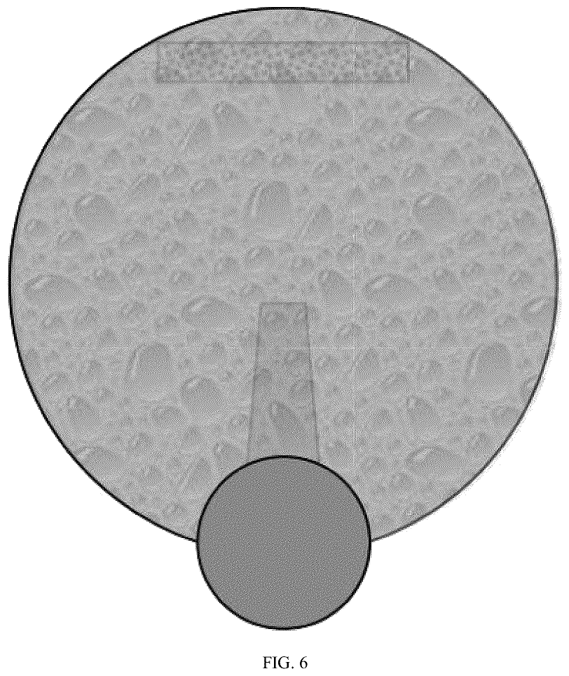

FIG. 7 is a schematic diagram of the structure of the electrode plate.

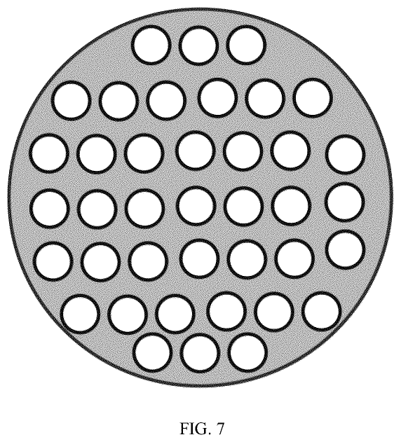

FIG. 8 is a schematic diagram of the structure of the host machine.

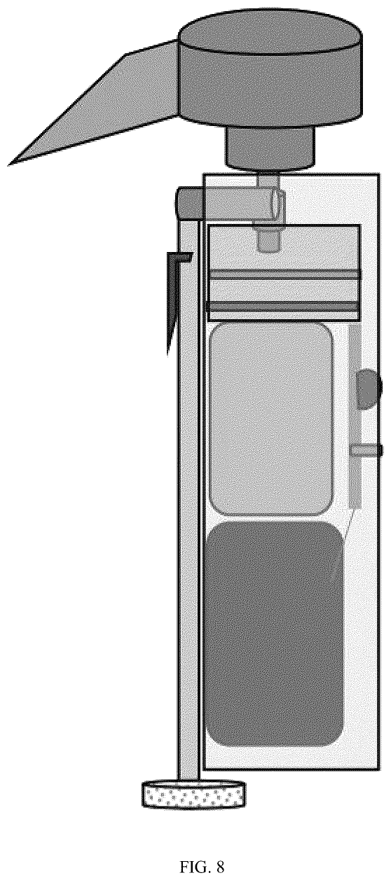

### 5. SPECIFIC EMBODIMENT OF THE INVENTION

In order to facilitate understanding of the invention, the invention will be described more fully below in combination with the relevant accompanying drawings.

Preferred embodiments of the invention are shown in the accompanying drawings. However, the invention may be embodied in many different forms and is not limited to the embodiments described herein. On the contrary, the object of providing these embodiments is to provide a thorough and comprehensive understanding of the invention.

### Embodiment

Combined with the accompanying drawings, an intelligent pet oral cleaning water dispenser comprises a water tank 19; a detachable water storage area 4 and a host machine are arranged on the water tank; a water leakage port 12 is arranged on the detachable water storage area; a filter screen 10 is arranged below the water leakage port; a diverted and distributed water pipe 1 is arranged on the uppermost part of the host machine; the bottom of the diverted and distributed water pipe is connected to a water outlet 2; a water inlet 3 is arranged next to the water outlet; a reaction tank 17 is arranged below the water inlet and the water outlet; a micropump 14 is arranged below the reaction tank; a circuit board 6 is arranged next to the micropump; a switch 18 and a charging port 7 are arranged on the circuit board; a battery 8 is arranged below the micropump.

As a preferred implementation of this embodiment, the water inlet is connected to the water body of the water tank 9 through a latex hose 15; one end of the latex hose immersed in the water tank is connected to the filter head 16.

As a preferred implementation of this embodiment, an anode plate 11 and a cathode plate 5 are arranged in the reaction tank.

As a preferred implementation of this embodiment, a hook 13 is arranged on the tube.

As a preferred implementation of this embodiment, both the water tank and the reaction tank are made of polypropylene or acrylonitrile-butadiene-styrene copolymer.

As a preferred implementation of this embodiment, the electrode sheet is a porous electrode sheet.

In the specific implementation of the invention, the switch is turned on, the micropump starts, and tap water/mineral water in the water tank is drawn into the reaction tank through the filter head, inlet pipe, and water inlet under the drive of the pump, with a flow rate of 2-20 mL/min. When water immerses the cathode and anode plates embedded in the reaction tank, the water is electrolyzed into oxygen at the anode plate and hydrogen at the cathode plate. The diameters of the oxygen and hydrogen bubbles are controlled by the plating structure of the electrode surface, with the average diameter of oxygen and hydrogen bubbles in the invention being 100-300 nm. The oxygen and hydrogen bubbles serve as the active components for sterilization in the invention. The water rich in micro-nano bubbles flows into the water storage area for pets to drink under the drive of the micropump through the water outlet, outlet pipe, and diverted and distributed water pipe. The surface of micro-nano bubbles carries a negative charge, and at the moment of rupture, a large amount of energy can be released to convert hydroxyl groups in the water into hydroxyl radicals for sterilization. In addition, the residence time of micro-nano bubbles in water is inversely proportional to their diameter, with nanoscale bubbles being able to remain in water for several months, providing sufficient active lifespan for oral sterilization of pets.

Wherein, both the water tank and the reaction tank are made of plastic with good heat resistance, non-toxic, and harmless to pets such as polypropylene or acrylonitrile-butadiene-styrene copolymer; the battery used is 10V==2 A; the outlet pipe and inlet pipe are made of latex hoses; the electrode sheet use the porous electrode sheet with a pore size of 2-4 mm and a density of 4-10 holes per square centimeter; the surface composition of the electrode sheet include semiconductor materials such as titanium dioxide, iron oxide, and carbon nitride. The water leakage port is used to control the capacity of the water storage area, preventing wastage of water resources; the filter screen is arranged below the water leakage port to prevent solid residues scattered when pets drink water from entering the water tank and contaminating the water body; the lower end of the inlet pipe is provided with the filter head to further prevent impurities from entering the reaction tank. All materials in contact with the water in this invention are made of non-toxic, stable, and anti-oxidation materials to prevent harm to pets' bodies.

1. An intelligent pet oral cleaning water dispenser comprises a water tank; a detachable water storage area and a host machine are arranged on the water tank; a water leakage port is arranged on the detachable water storage area; a filter screen is arranged below the water leakage port; a diverted and distributed water pipe is arranged on the uppermost part of the host machine; the bottom of the diverted and distributed water pipe is connected to a water outlet; a water inlet is arranged next to the water outlet; a reaction tank is arranged below the water inlet and the water outlet; a micropump is arranged below the reaction tank; a circuit board is arranged next to the micropump; a switch and a charging port are arranged on the circuit board; a battery is arranged below the micropump.

2. The intelligent pet oral cleaning water dispenser of claim 1, the water inlet is connected to the water body of the water tank through a latex hose; one end of the latex hose immersed in the water tank is connected to the filter head.

3. The intelligent pet oral cleaning water dispenser of claim 1, an anode plate and a cathode plate are arranged in the reaction tank.

4. The intelligent pet oral cleaning water dispenser of claim 1, a hook is arranged on the host machine for easy fixation on the tank.

5. The intelligent pet oral cleaning water dispenser of claim 1, both the water tank and the reaction tank are made of polypropylene or acrylonitrile-butadiene-styrene copolymer.

6. The intelligent pet oral cleaning water dispenser of claim 1, the electrode sheet is a porous electrode sheet.
